(19) United States
(12) Patent Application Publication
(10) Pub. No.: US 2017/0178186 A1
(43) Pub. Date: Jun. 22, 2017

(54) DEMAND AGGREGATION AND CALENDARING SYSTEM

(71) Applicant: Mack Craft, St. Augustine, FL (US)

(72) Inventor: Mack Craft, St. Augustine, FL (US)

(21) Appl. No.: 15/138,194

(22) Filed: Apr. 25, 2016

Related U.S. Application Data
(63) Continuation-in-part of application No. 14/973,702, filed on Dec. 17, 2015.

(51) Int. Cl. G06Q 30/02; G06F 17/30; H04L 12/58

(52) U.S. Cl. CPC G06Q 30/0255; G06Q 30/0277; H04L 51/18; G06F 17/30876

(57) ABSTRACT

Directives expressing interest in subject matter are entered in a database and matched with directives from providers for providing information, goods or services related to the interest. Other users may join a directive to aggregate shared interests. Providers may assent to (conditionally or unconditionally) a directive, thereby agreeing to fulfill the request. Providers may also disseminate counterproposals in response to a directive. Events relating to directives are calendared for display and notification on users' smartphones.

### RELATED APPLICATIONS

This application is a continuation-in-part and claims the benefit of priority of pending U.S. Nonprovisional application Ser. No. 14/973,702 filed 17 Dec. 2015, which is a continuation-in-part and claims the benefit of priority of pending U.S. Nonprovisional application Ser. No. 14/334,592 filed 17 Jul. 2014, which is a continuation-in-part and claims the benefit of priority of U.S. Nonprovisional application Ser. No. 14/058,119 filed 18 Oct. 2013, which is a Nonprovisional of and claims the benefit of priority of U.S. Provisional Application No. 61/795,497 filed on 18 Oct. 2012, the entire contents of which are incorporated herein by this reference and made a part hereof.

### FIELD OF THE INVENTION

This invention relates generally to marketing, and, more particularly, to a networked system that aggregates demand and disseminates and calendars responsive offerings and events.

### BACKGROUND

A problem with marketing, whether it involves a conventional advertisement, a coupon, a discount code, or some other form of marketing, is that it often reaches individuals and businesses who are not interested in the promoted business, product or service, and may fail to reach those who are truly interested. Thus, a business pays for broad distribution of an advertisement through print or electronic sources to many consumers, including many who may not be receptive to the advertisement. By way of example a business may publish coupons in a newspaper or other printed publication. Many of those coupons will not reach interested consumers. Many of those coupons will reach consumers lacking interest in the subject matter. While online coupon delivery systems have been devised, such systems are relegated to coupon delivery and still require a consumer to request specific coupons.

Online advertising uses the Internet to deliver promotional marketing messages to consumers. It includes email marketing, search engine marketing, social media marketing, many types of display advertising (including web banner advertising). Like other advertising media, online advertising frequently reaches consumers who are not interested in the content and fails to reach those who may be truly interested.

Online advertisers (typically through their ad servers) often use cookies, which are unique identifiers of specific computers, to decide which ads to serve to a particular consumer. Cookies can track whether a user left a page without buying anything, so the advertiser can later retarget the user with ads from the site the user visited. As advertisers collect data across multiple external websites about a user's online activity, they can create a detailed picture of the user's interests to deliver even more targeted advertising. Often the picture is inaccurate. This aggregation of data is called behavioral targeting. Online advertisers can also target their audience by using contextual and semantic advertising to deliver display ads related to the content of the web page where the ads appear. Re-targeting, behavioral targeting, and contextual advertising all are designed to increase an advertiser's return on investment, or ROI, over untargeted ads.

A problem with such online advertising is that it assumes, often erroneously, that a consumer's web search or a visit to a site or clicking of a hyperlink means that the consumer is interested in the subject matter. This is not always the case. Often, individuals visit online sites and select links inadvertently, mistakenly or indiscriminately, without an interest in the underlying subject matter. Occasionally, a consumer's interest may be transient. By way of example, after a consumer completes the purchase of a new home, that consumer may no longer be interested in home inspection services, notwithstanding prior web searches and online visits to websites promoting such services. In such a case, advertising dollars are squandered and the consumer is alienated if targeted banner ads continue to promote home inspection services to the consumer.

A related problem is unsolicited commercial email, often referred to as SPAM. Such email is often sent indiscriminately to all users on a list, regardless of their interests. Not only does such email consume storage and bandwidth, but it infuriates many consumers. Concomitantly, many email applications do a good job at identifying such email as SPAM and move them to a junk folder or delete them upon receipt. Thus, a consumer may never even see such email.

Other problems are an inability of consumers to aggregate their demands to encourage suppliers to offer particular goods and/or services, or discounts or other savings. Today, consumers lack tools to structure aggregated bids or requests to present to suppliers. Likewise, suppliers lack tools to structure an offering to an aggregate of consumers who have expressed interest. Similarly, such tools are unavailable to assist owners of physical objects that are sensed and monitored via the Internet as part of the Internet of Things (IoT) to aggregate their needs for supplies and services.

Still other problems are an inability to track opportunities, such as opportunities to participate in offerings of goods and services, including sales, opportunities to attend events, opportunities to watch programs or live performances, opportunities to unite with other consumers in requesting a sale or particular goods or services. In the past, emails have been used to communicate sales or events to subscribers. If an email is not read carefully, or overlooked or set aside as SPAM, the email is ineffectual. Even if an email is actually accessed, a user may fail to read it carefully in its entirety, overlooking important time sensitive information. This is particularly true for any emails read by mobile device, and even more particularly true if the email is lengthy or contains multimedia objects.

The invention is directed to overcoming one or more of the problems and solving one or more of the needs as set forth above.

### SUMMARY OF THE INVENTION

To solve one or more of the problems set forth above, a computer network enabled calendaring method according to principles of the invention operates using a computer system with one or more computers and network (e.g., Internet) connectivity. The computer system receives via the network, a first directive. The first directive includes first directive data, which includes a first subject matter and a first user identification. The first subject matter expresses a first interest. By way of example, a user may create a directive expressing interest in a performer, or a brand, or a retailer, or a television program, or a product or a service or something else. The computer system enters the first directive data in at least one database on the computer system.

The computer system receives, via the computer network, a second directive, which includes second directive data. The second directive data includes a second subject matter responsive to the first interest and a second time associated with the second subject matter. The computer system determines if the second directive includes second subject matter responsive to the first interest. The computer system enters the second directive data in a database on the computer system. Illustratively, the second directive may offer to sell tickets to a performance, or offer goods of a particular brand, or provide information about a sale at a retailer, or provide information about a television program, or offer a particular product or service or something else in response to the first directive.

The computer system adds a first event to first calendar data for a first calendar associated with the first user identification. The first event identifies the second subject matter and includes the second time. The addition is accomplished by sending the data for the event to the address for the calendar application in accordance with an API for the calendar application. Thus, for example, the first user's calendar data is updated with a new event for the second directive.

The first directive may be provided in a number of ways. For example, the first directive may be input by a first user via the computer network or generated from information input by a first user via the computer network, or the first directive may be generated from a message provided by equipment, via the Internet of Things (IoT). The content of such a message identifies the equipment (e.g., via a unique identifier) and contains data (e.g., a code) that defines the reason for the message (e.g., a code for a low toner warning for a printer).

The first directive may be made available to a plurality of other users. For example, the first directive or data or a link for the first directive may be shared with (e.g., emailed or texted [SMS] to) other users or published (e.g., displayed online) for viewing by other users. Such other users may become associated with the first directive by joining the first directive. Joining entails expressing assent, which may be accomplished with a control, which when selected associates the identifier for the selecting user with the directive. In this manner a plurality of users may join the directive. Such a plurality of users is referred to herein as a consumer group. The calendars of all members of the consumer group may be updated with the first event and each subsequent event relating to the directive.

Illustratively, many users may share the interest in a performer, or a brand, or a retailer, or a television program, or a product or a service or something else expressed in a first directive. By joining the first directive, the users aggregate their demand. The aggregation may appeal to potential providers and may warrant action that a single user's interest could not, in and of itself, compel.

A provider may react to the first directive in any number of ways. The provider may ignore it and not participate. The provider may assent to it in the second directive, in which the provider expresses its intent to fulfill or satisfy the interest set forth in the first directive. Illustratively, the second directive may offer to sell tickets to a performance, or offer goods of a particular brand, or provide information about a sale at a retailer, or provide information about a television program, or offer a particular product or service or something else in response to the first directive. The assent may be conditional or unconditional. An unconditional assent offers fulfillment of the interest as set forth in the first directive. A conditional assent offers fulfillment subject to certain additional or different terms. Additionally, a provider may propose, in the second directive, an alternative to the interest expressed in the first directive.

Illustratively, if a first directive calls for a particular brand and model number of toner cartridge, the second directive may offer the requested brand and model number, or may offer an alternative brand and model number that fits the same printers, or may offer something different such as a high capacity model of the toner cartridge, or may offer any combination of the foregoing.

While a user may create a directive, that is but one way of directive creation. Directives may be created by the computer system in response to determined interests. For example, a directive may be created by the computer system in response to a message received from equipment, i.e., equipment that has previously been registered with the system. Registration associates an identification for the equipment with an identification for the user. Thus, the system associates the equipment with the user. Such association may be accomplished through a directive. For instance, a first user may produce a first directive including first directive data, with a first subject matter and a first user identification, wherein the first subject matter includes a first equipment identification. The computer system enters the first directive data in at least one database on the computer system and associates the first directive data with the first user identification. Subsequently, the computer system may receive, via the computer network, a first message from the first equipment. The first message may include the first equipment identification and a first message content. By way of example, the first message content indicating a need for one of a product and service. In response, the computer system may create a second directive, including the first user identification, the first equipment identification, the first message content and a time. The computer system may then add a first event to first calendar data for a first calendar associated with the first user identification. The first event may identify the second subject matter and include the second time. The computer system may enter the second directive data in at least one database on the computer system.

Subsequently, the computer system may receive, via the computer network, a third directive. The third directive may include third directive data, with a third subject matter responsive to the first message content of the second directive, and a third time associated with the third subject matter. The computer system determines if the third directive includes third subject matter responsive to the first message content of the second directive. The computer system enters the third directive data in at least one database on the computer system. The computer system adds a second event to the first calendar data for the first calendar associated with the first user identification. The second event identifies the third subject matter and includes the third time.

The first message may be provided in a number of ways. The first message being forwarded to the system by a first user via the computer network. It may be communicated directly from the equipment to the computer system, via the Internet. The message may be a copy of a message produced by the equipment or the original message produced by the equipment.

The computer system may aggregate demand by associating the second directive with a plurality of users, such as a first user, a third user and a fourth user. Users may join the directive by entering a join command (e.g., by selecting a join control), as described above. The computer system may then add the first event to third calendar data for a third calendar for the third user and to fourth calendar data for a fourth calendar for the fourth user.

A provider may react to the second directive in any number of ways. The provider may ignore it and not participate. The provider may assent to it in the third directive, in which the provider expresses its intent to fulfill or satisfy the interest set forth in the second directive. Illustratively, the third directive may offer to sell tickets to a performance, or offer goods of a particular brand, or provide information about a sale at a retailer, or provide information about a television program, or offer a particular product or service or something else in response to the second directive. The assent may be conditional or unconditional. An unconditional assent offers fulfillment of the interest as set forth in the second directive. A conditional assent offers fulfillment subject to certain additional or different terms. Additionally, a provider may propose, in the second directive, an alternative to the interest expressed in the second directive.

In another implementation, an aggregate directive is generated by receiving, on a computer system, via a computer network, a first directive, the first directive including first directive data. The first directive data includes a first subject matter and a first user identification. The first subject matter expresses a first interest. The computer system enters the first directive data in at least one database on the computer system. The computer system provides the first directive data to a plurality of users, including a third user and a fourth user. The computer system associates the first directive with the plurality of users, including a first user, the third user and the fourth user. The first user is associated with the first user identification. The third user is associated with a third user identification. The fourth user is associated with a fourth user identification. Thus, the first, third and fourth users comprise a consumer group, each associated with the first directive, which is now an aggregate directive that aggregates the demands of the associated users.

The computer system may receive, via the computer network, a second directive, which includes second directive data with a second subject matter responsive to the first interest and a second time associated with the second subject matter. The computer system determines if the second directive includes second subject matter responsive to the first interest. The computer system enters the second directive data in at least one database on the computer system. The computer system then communicates the second directive data to the plurality of users via the computer network. The second directive data may include an assent, a conditional assent or a counter-proposal.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a high level block diagram illustrating components of an exemplary system according to principles of the invention; and

FIG. 2 is a high level flowchart of an exemplary method of creating a directive according to principles of the invention; and

FIG. 3 is a high level flowchart of an exemplary method of creating another directive according to principles of the invention; and

FIG. 4 is a high level flowchart of an exemplary method of matching directives according to principles of the invention; and

FIG. 5 is a high level flowchart of an exemplary method of communicating matches to user(s) according to principles of the invention; and

FIG. 6 is a high level block diagram of components of an exemplary mobile device for use with an exemplary system and method according to principles of the invention; and

FIG. 7 is a high level block diagram of software modules of an exemplary system according to principles of the invention; and

FIG. 8 is a perspective view of an exemplary mobile device for use with an exemplary system according to principles of the invention; and

FIG. 9 provides a high level flowchart of steps of an exemplary aggregate directive process according to principles of the invention; and

FIG. 10 provides a high level flowchart of steps of another exemplary aggregate directive process according to principles of the invention; and

FIG. 11 provides a high level flowchart of steps of another exemplary aggregate directive process according to principles of the invention; and

FIG. 12 is a plan view of an exemplary calendar display according to principles of the invention.

Those skilled in the art will appreciate that the figures are not intended to illustrate every embodiment of the invention. The invention methodology is not limited to the exemplary implementations depicted in the figures or the specific components, configurations, steps, or order of steps as shown in the figures. The text assigned to flowchart steps and block diagram elements are provided for reference purposes and not intended to limit any such element, step or the invention.

### DETAILED DESCRIPTION

An exemplary implementation of a demand aggregation, bidding and calendaring system according to principles of the invention enables users to establish a demand in the form of an aggregate directive. The aggregate directive is a request for goods or services under certain conditions. The conditions may include, for example, location, temporal and/or financial terms. By way of example, a user may create an aggregate directive requesting that an entertainer perform at a particular venue, or at a particular venue on a particular date or range of dates. As another example, a user may create an aggregate directive requesting that a broadcaster or webcaster show a particular program on a particular date or range of dates. As another example, a user may create an aggregate directive requesting a sale for particular goods or services on a particular date or range of dates. As another example, a user may register their devices that are operable via the Internet of Things (TOT), which may generate an aggregate directive requesting a sale for particular goods or services on a particular date or range of dates. In each case, aggregate directives may be aggregated (i.e., combined). Internet of Things (IoT) is the network of physical objects—devices, vehicles, buildings and other items—embedded with electronics, software, sensors, and network connectivity that enables these objects to collect and exchange data. The IoT allows objects to be sensed and controlled remotely across existing network infrastructure, creating opportunities for integration of such objects into a computer-based system according to principles of the invention, resulting in improved efficiency, accuracy and economic benefit.

If a starter of a car is going bad, the starter will trigger a response to the manufacturer, the retailers that carry the product, the service departments of automobile dealerships, and the consumer. The consumer is notified via calendar the date and time the starter sends the initial response and notified with the date and time the starter is expected to expire or die out. The retailer or automobile service department is simultaneously triggered from the response of the starter. The retailer or service department's calendar and scheduling system is automatically receiving data from the consumer, the consumer's calendar, the consumer's car, and the consumer's starter about the expiration date of product and then replies back to the consumer with available times and dates in which they can do the service or replace the product. The consumer's calendar is triggered and updated with multiple retailers and automobile service department's available times and dates requesting the consumer's services. The consumer, via calendar, can the decided on which dates and times is best for them and send a confirmation via calendar and then system will automatically schedule the appointment for both. Scheduling is automatically between the consumer and retailer or service department in consumer or product driven calendar. The calendar can also work from business to business between manufacturer and retailers or service departments.

Aggregate directives may be combined to accumulate demand. Other users may have generated the same or similar aggregate directive. Aggregate directives can be combined. Other users may have expressed interest in the subject matter of an aggregate directive. These users may be invited to join an aggregate directive.

Details of an aggregate directive, including the expiration date, number of participating users and targets may be published for viewing by other users and potential suppliers. Publication offers users an opportunity to join. Publication also offers potential suppliers an opportunity to accept or condition their acceptance of an aggregate directive.

Suppliers may express their willingness to satisfy an aggregate directive (i.e., accept) or to satisfy an aggregate directive under certain conditions (i.e., counter or counteroffer). For example, a supplier may agree to satisfy an aggregate directive if the demand (i.e., number of participating users) reaches a certain level within a certain time-limit. Alternatively, a supplier may agree to satisfy an aggregate directive if a requested discount is changed to another amount conditionally offered by the supplier. As another alternative example, a supplier may agree to satisfy an aggregate directive if requested date(s) or time(s) are changed.

Dates pertaining to an aggregate directive may be calendered. Calendaring may entail generating a calendar file (e.g., .ics file) with date and aggregate demand information (which may include hyperlinks). The calendar file is sent to a user's calendar application for importing. Alternatively, a system according to principles of the invention may read from, write to, and modify, via the web, calendar data for calendar (e.g., Google Calendar) services that provide external access to data and functionality through an API (e.g., the Google Data Protocol). Thus, for example, a user's calendar may be updated to indicate when a pending aggregate directive expires, the date(s) and time(s) for fulfillment of an aggregate directive accepted by a supplier, and reminders for approaching deadlines.

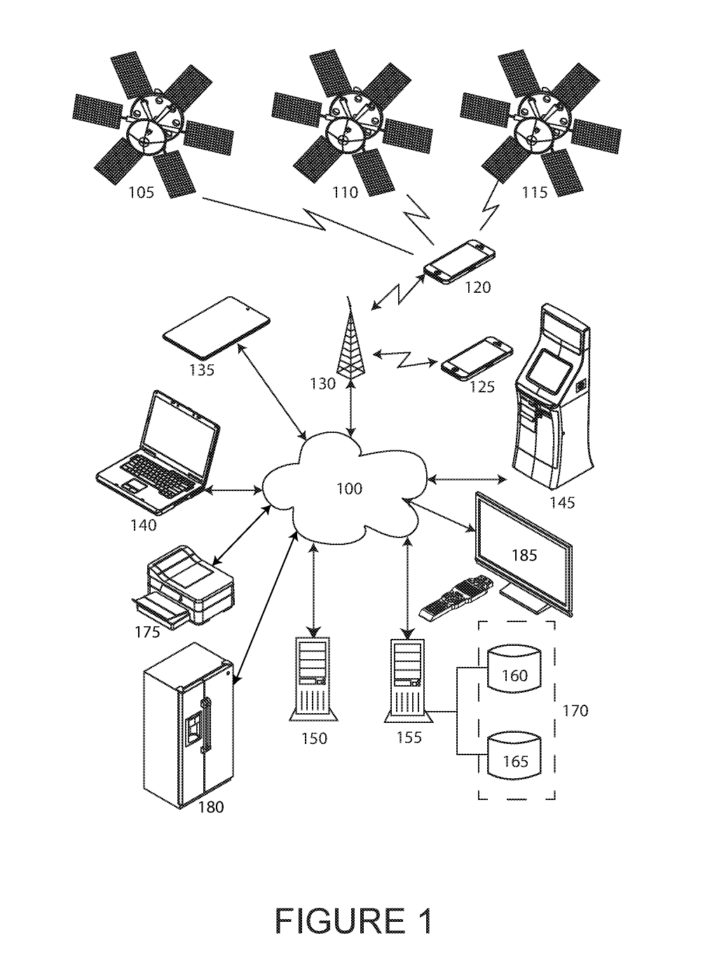

Referring now to FIG. 1, a high level block diagram of hardware components of a system according to principle of the invention is conceptually illustrated. Consistent with the present invention, users of the system use computing devices, such as a cellular phones 120, 125, a tablet 135, a laptop computer 140, 145, or a desktop computer 150, communicating in a wireless or wired mode, with and through one or more web servers 155, via the Internet 100. The computing devices (i.e., clients or client devices) are equipped with software for inputting and displaying information. Such software may comprise a web browser and/or a mobile device app. Some computing devices 120, 125 may be equipped with cellular wireless communication modules providing Internet access via wireless cellular communication infrastructure 130. The equipment 175, 180 is registered for use with the system. The original or a copy of each message from the registered equipment may be routed to the server 155, which, upon receiving the message, decodes it and determines the user, equipment and message content. If the message indicates a need for goods or services (e.g., toner or ink cartridges required for a printer, a water filtration element required for a refrigerator, an oil filter and oil required for an automobile) a corresponding aggregation directive may be generated. If the original message, rather than a copy is received by the server 155, the server may send a copy of the original message to another destination (e.g., a service provider or manufacturer).

IoT equipment, such as printers 175 and appliances 180 (e.g., televisions, refrigerators), and vehicles that are communicatively coupled to the Internet 100 may also communicate with one or more web servers 155.

A game console coupled to a television, recording/reproducing (DVR) device coupled to a television and a SmartTV 185, are additional non-limiting examples of computing devices (i.e., computers) that users may use to interact with a system according to principles of the invention and enable performance of methods in accordance with principles of the invention, including receiving and displaying information and sending information. Any device that may process and send data to and receive data from the server 155 via the internet and display textual and graphical information on a monitor constitutes a computer for purposes of the invention.

In certain embodiments of a system and methodology according to the principles of the invention, a user's location may be specified. Location may be user input or automatically determined using GPS data, IP trace or triangulation information. Some computing devices may be equipped with Global Positioning System (“GPS”) receivers for receiving signals from GPS satellites 105-115 to determine location of the device. Location information may be used for determining a location for services to be provided (e.g., restaurant, live entertainment, hotel and transportation).

Location information may be used for determining location for location-dependent services. Nonlimiting examples of such services include restaurant, hotel, transportation, and live entertainment).

Certain clients 120, 125, 135-150 may not have access to a GPS service (for example, they may lack hardware necessary to support such a service); consequently, such GPS information may not be available for all clients 120, 125, 135-150. Also, it is observed that certain GPS services do not operate or do not operate well in certain locations, such as indoors. Thus, even if a client 120, 125, 135-150 does have the necessary hardware and software to support a GPS service, occasionally GPS information from the GPS service may not be available to a particular client 120, 125, 135-150.

IP trace information may include the public IP address of the client 120, 125, 135-150 and the set of IP addresses that data packets sent from the client 120, 125, 135-150 pass through to reach server 150. The public IP address of the client 120, 125, 135-150 may be determined by gathering the source IP address from the server socket receiving the client 120, 125, 135-150 connection. The list of hops through which the data packets sent from the client 120, 125, 135-150 go through may be determined by sending adaptive TTL (time to live) UDP packets to server 150 from the client 120, 125, 135-150. In order to determine if the client 120, 125, 135-150 is being an IP proxy, server 150 may correlate the list of hops with the public IP address of the client 120, 125, 135-150. In this way, server 150 may effectively discover the real public IP address of the client 120, 125, 135-150. The real public IP address of the client 120, 125, 135-150 is then matched against a database of Internet Service Providers (ISPs) which returns the probable address of the originating client 120, 125, 135-150 message. This probable address of the originating client 120, 125, 135-150 message may then be translated to a set of longitude and latitude coordinates.

Triangulation information for a client 120, 125, 135-150 may include a list of public Wi-Fi access points surrounding the client 120, 125, 135-150 as well as the signal strength of each Wi-Fi access point accessible by the client 120, 125, 135-150. The list of surrounding Wi-Fi access points, and their signal strength, may be formatted and correlated with a database of public Wi-Fi access points by server 150 to determine a probable set of longitude and latitude coordinates for the client 120, 125, 135-150. The database of public Wi-Fi access points employed by server 150 may be updated over time to reflect new information about available Wi-Fi access points.

The invention is not dependent upon location information. Certain implementations of the invention may not take location into consideration. In implementations that take location into consideration, certain types of location data may be more accurate or reliable than others. GPS information is more accurate and indicative of the correct physical location of a client 120, 125, 135-150; however, as explained above, GPS information for a particular client 120, 125, 135-150 may not always be available. Triangulation information, while not as accurate and reliable in identifying the correct physical location of a client 120, 125, 135-150 as GPS information, is more accurate and reliable than IP trace information. However, triangulation information also may not always be available, e.g., the client 120, 125, 135-150 may not be able to detect any nearby recognizable Wi-Fi access points. Additionally, while IP trace information is less accurate than either GPS information or triangulation information in determining the correct location of a client 120, 125, 135-150, it is always obtainable if the client 120, 125, 135-150 can communicate to server 150 over the Internet.

Additionally, a consumer may input location (e.g., an address) for a device, such as a personal computer, laptop 140, 145 or tablet 135, that may not be equipped with a GPS receiver. For a device, such as a desktop computer, at a fixed location, the location of the device may be known and associated with a unique identifier (e.g., MAC address) for the device.

The term “service provider” is used herein to mean any entity that provides a service using a system or methodology according to principles of the invention. The service provider may be, for example, an online service provider with a web-accessible system that receives and processes directives and marketing objects according to principles of the invention. The term “consumer” or “customer” is used herein to mean any individual or entity that requests or seeks marketing objects or goods or services of a business, whether for free or in exchange for compensation. The term “user” or “end user” is used herein to mean any individual or entity that uses the system, whether as a business promoting goods or services or as a consumer interested in procuring goods or services.

Using the computing device 120, 125, 135-150 and client software (“client”) such as a browser or app, a user may create a directive. A directive comprises an authoritative instruction requesting or initiating an electronically deliverable service or information (e.g., a marketing object). A directive may be a consumer directive or a marketing directive. A consumer directive may be one of many different types, including, but not limited to, a location directive, a personal information directive, a general directive, specific directive or an aggregate directive. The system stores data for each directive as one or more records in a database 170. A user may access, change and delete directives using the system.

Referring still to FIG. 1, one or more computers such as server 155 includes or has access to a database management system for managing product data. One or more database may contain aggregations of data records or files, pertaining to products, users, and directives. A communications network interconnects the server 155, directly or indirectly through one or more additional computers, with the Internet 100. Interconnected computers communicate with each other through mechanisms such as interprocess communication, remote procedure call, distributed object interfaces, and various other program interfaces. The databases may be stored on one or more storage devices 160, 165, collectively the data storage 170. The database may be queried using various database access means such as SQL (Structured Query Language), a standard language for interacting with a database; Open Database Connectivity (ODBC), an open standard API for accessing a database; DCOM (Distributed Component Object Model), a set of Microsoft tools and program interfaces for enabling client program objects to request services from server program objects on another networked computer; Common Object Request Broker Architecture (CORBA), an architecture and specification which allows programs at different locations and developed by different vendors to interact in a network through an interface broker. Illustratively, the clients 120, 125, 135-150 may execute one or more processes that interact server 155 to access data, such as product data, stored on the data storage 170. Each request received by the server 155 may be submitted as a TCP/IP communication packet including an IP address and socket number. In response to valid requests, the server 155 may provide data from the data storage 170, without compromising the integrity of the database.

A location directive identifies the user and provides location information for the user. The location information may comprise an address such as a home, business or temporary address, or another location. A location directive may be time bound, i.e., effective for a user-specified period of time.

A personal information directive may provide some or all of a user's gender, race, age, religion, marital status, income level, education level, profession, and personal interests to facilitate delivery of marketing objects pertaining thereto. Items of data may be optional, to accommodate users with heightened sensitivity to privacy and/or anonymity.

A general directive remains active until canceled. A general directive identifies goods, services, categories of goods and services, brands, or other identifiable classificatory division of subject matter that is of interest or desired by a user. The general directive identifies the user and the subject matter of interest. A graphical user interface may present a user with a form that allows a user to identify a multitude of subject matter of interest. From the form, a general directive may be produced for each subject matter. By way of example and not limitation, one category may be pickup trucks and another category may be Ford F150® pickup trucks.

A specific directive is a specific request. A specific directive identifies goods, services, categories of goods and services, brands, or other identifiable classificatory division of subject matter that is required or desired by a user. The specific directive identifies the user and the subject matter required. A graphical user interface may present a user with a form that allows a user to identify each subject matter required. From the form, a specific directive is produced for each subject matter. Specific directives may be processed immediately or as soon as practicable. A specific directive may be time bound, i.e., limited in duration (e.g., for a day, week, month, until an end date, etc. . . . ). By way of example and not limitation, a specific directive may request coupons for a particular business. The specific directive may be limited to a particular day when the coupons are needed. After that day, the coupons will not be provided unless requested again.

If a Starter of a car is going bad, the Starter will trigger a response to the Manufacturer, the retailers that carry the product, the service departments of automobile dealerships, and the consumer. The consumer is notified via calendar the date and time the starter sends the initial response and notified with the date and time the starter is expected to expire or die out. The retailer or automobile service department is simultaneously triggered from the response of the Starter. The retailer or service department's calendar and scheduling system is automatically receiving data from the consumer, the consumer's calendar, the consumer's car, and the consumer's Starter about the expiration date of product and then replies back to the consumer with available times and dates in which they can do the service or replace the product. The consumer's calendar is triggered and updated with multiple retailers and automobile service department's available times and dates requesting the consumer's services. The consumer, via calendar, can the decided on which dates and times is best for them and send a confirmation via calendar and then system will automatically schedule the appointment for both. Scheduling is automatically between the consumer and retailer or service department in consumer or product driven calendar. The calendar can also works from business to business between manufacturer and retailers or service departments. The computer chip or remote on the devices will trigger the calendar and scheduling system in the IoT invention. The specific directive may search for a product, service, or entertainment information requested by the user that doesn't currently exist and then remains active until such information or change of condition becomes publicly or privately available. Once the information or change is available, the user's calendar is triggered and notified with the requested information, and the advertising reflecting change, product or service information is displayed. A specific directive may come with a good faith cost or deposit for purchase of goods, services, and entertainment or product conditions that doesn't currently exist. Once the deposit is made, the user is guaranteeing the purchase of the product, service, or entertainment if the condition is changed or met and the product or service is also guaranteed to the user by the supplier. When condition is met, the user is notified via calendar. If the user, after deposit, decides not to buy the product or service, then the deposit is retained or not refunded.

An aggregate directive is a specific directive that may be associated with an originating user and one or more additional users who share the need or desire expressed in the aggregate directive, and have either generated an identical or closely similar directive or affirmatively joined or assented to another user's aggregate directive. An aggregate directive may be associated with more than one user. Each associated user is deemed to have “joined” the directive. The user that initiated the aggregate directive is the “originating” user. An originating user is associated with the aggregate directive and deemed to have “joined” the directive. All users that have joined an aggregate directive, including the originator, comprise a “consumer group.” Thus, a consumer group may be associated with an aggregate directive.

Illustratively, a user may generate an aggregate directive requesting a movie to be televised, or a musical group to perform at a local venue, or a particular merchant to run a sale. The originator may share or publish the aggregate directive to solicit support from other users. Some of the other users may join the aggregate directive. The aggregate directive may be sent to providers who can fulfill the aggregate directive. By associating a plurality of users with an aggregate directive, a provider is reasonably assured of a certain volume of business, patronage, viewers, etc. . . . . Thus, an aggregate directive facilitates volume discounts and ensures adequate demand to justify a transaction. A provider may agree to fulfill an aggregate directive, or may offer to fulfill an aggregate directive when the consumer group associated with the aggregate directive reaches a certain size. Thus, an aggregate directive provides incentive to a provider.

Users may learn of an aggregate directive upon receiving a copy. The system may send aggregate directives to users, both consumers and suppliers, particularly those with an expressed interest in the subject matter of the aggregate directive.

Users may also learn of aggregate directives by searching or browsing. Users may perform searches (e.g., keyword searches) for aggregate directives. Aggregate directives may be categorized and subcategorized to enable browsing.

Users may join an aggregate directive by selecting a “join” control associated with the aggregate directive. Upon user selection of the control, the user's identification and a timestamp are associated with the aggregate directive in one or more tables or databases.

Users who have created identical or closely similar aggregate directives may be invited to join one of the similar aggregate directives, and to consolidate the aggregate directives by deleting the other one of the similar directives. An originator may delete an aggregate directive.

In response to an aggregate directive, a provider may generate a marketing directive with a marketing object. The marketing directive may be conditional or unconditional. A conditional marketing directive operates as an offer that is accepted when each specified condition is satisfied. An unconditional marketing directive accepts the aggregate directive and operates as an expression of intent to provide the products or services requested in the aggregate directive.

A marketing directive generated in response to an aggregate directive may be published and/or disseminated. Publication allows the marketing directive to be viewed by all users. Dissemination (e.g., via email, SMS, pop-up or the like) to potentially interested users informs prospective members of a consumer group, giving them an opportunity to join the aggregate directive and/or to consolidate their own aggregate directive with the forwarded aggregate directive. Concomitantly, the marketing directive informs the user of acceptance or conditions for acceptance.

The service provider's computing device 155 includes a server (e.g., web server) accessible via a network such as the Internet 100. The server 155 is communicatively coupled to one or more databases 160, 165 and operates a database management system (DBMS) that stores, updates, sorts, queries and analyzes structured data in one or more databases 160, 165, and produces reports and output based on the data. The databases 160, 165 may reside on or local to the server 155, or remote from the server, hosted by a third party and accessible via a network such as the Internet 100. Collectively, the databases are referred to as a database 170.

A marketing directive instructs the system to which users the system should send a corresponding marketing object. A marketing directive may specify users by subject matter of interest or by personal attribute or by location, as set forth in consumer directives (e.g., location, personal, specific or general directives). A marketing directive is associated with a marketing object. The marketing object is an image, file, stream or data that will be forwarded to each user with a consumer directive that matches a marketing directive. The marketing object may be stored in the database 170.

Time bound provisioning is available. All directives may be time bound. In other words, a directive may be active for a limited period of time, defined in hours, days, weeks, months or years. For example, a general directive may be time bound for a year. The user associated with the general directive may receive a reminder of the time limit prior to the expiration, giving the user a chance to re-provision or remove the time limit. As another example, a merchant user may impose a time limit on a marketing directive for a coupon. The marketing directive may expire on a determined date. Time provisioning, the user can make a purchase once the marketing object of information is calendared or scheduled for notification.

Unit provisioning is also available. For example, a merchant may want to limit a marketing directive to a maximum of 100 or 1000 or 100000 users or transactions. In this case, after the unit limit is reached, the marketing directive expires. The unit limit is reached when the number of copies made available to users equals the unit limit or when the number of transactions using the marketing directive (e.g., using a coupon provided with the marketing directive) exceeds a unit (e.g., transactional) limit. For fairness, in one implementation, the limited number of users may be determined randomly, or using a random selection algorithm, from all users with consumer directives to which the marketing directive is responsive. Alternatively, the limited number of users may be selected based on seniority of their consumer directives—first posted, first served. These and other user selection criteria may be employed if a unit limit must be applied. In the case of a transactional unit limit, the limit may be applied on a first come first served basis. Unit provisioning or transactional unit limit may come with a good faith cost or deposit for purchase of goods, services, and entertainment or product conditions that doesn't currently exist. Once the deposit is made, the user is guaranteeing the purchase of the product, service, or entertainment if the condition is changed or met and the product or service is also guaranteed to the user by the supplier. When the condition is met, the user is notified via calendar. If the user, after deposit, decides not to buy the product or service, then the deposit is retained or not refunded.

A database management system executable via the server 155 saves each received directive as a record in a database referred to as a directive repository 160, 165. Directives and marketing objects may be stored in the same or separate databases. Consumer directives and marketing directives may be stored in the same or separate databases. Other data, including user account data and online shopping data may also be stored in repositories 160, 165 or one or more other databases.

The database management system, also referred to as an engine, provides processing, including querying and distribution. Querying entails searching for and retrieving information from the database 170. By way of example, a query may be run for each marketing directive to identify matching consumer directives. Then, each marketing object associated with the marketing directive may be provided to or made accessible to the user associated with each matching consumer directive. If a user has several consumer directives that match a marketing directive, only one copy of the marketing object should be sent or made available. A consumer directive matches a marketing directive when the consumer directive identifies the subject matter of the marketing directive. Marketing objects may be provided to users by sending copies, such as by email or SMS messaging, or by providing a link or other form of notification for the user to access or download the marketing object. In this manner, businesses may push advertisements, information, and coupons to consumers.

A marketing object may be provided by a consumer or a business. A marketing object may comprise any of a wide variety of marketing items, such as coupons, announcements, advertisements, promotional codes, job postings, resumes, personal profiles, etc. . . . Thus, as one nonlimiting example, a marketing object may comprise a coupon (as broadly defined above) for a restaurant to be sent to all users in a certain location (e.g., northeast Florida) who have entered a directive for restaurants, or restaurants of the particular type, or that particular brand of restaurant. As another nonlimiting example, a marketing object may comprise an individual's resume, to be made available to all business users in a certain location (e.g., southern California) who have posted a consumer directive seeking employees in the field of endeavor specified in the marketing directive associated with the resume. As yet another example, a marketing object may comprise information about a new product or event to be sent to all users who have expressed interest in the product or event, or in products or events of the kind.

The system includes a portal for registered users to access features of the system. The portal may be accessed via a web page and/or an app (i.e., an application executable on a computing device). Through the portal, a user may create a directive and/or provide a marketing object. The portal may provide user-navigable forms to facilitate directive creation and marketing object submission.

Illustratively, a form may include form controls and fields to be manipulated and completed by a user. Such controls and fields may include check buttons, radio buttons, sliders, flip flopping windows, list boxes, drop-down lists, spinners, combo boxes, text boxes and upload buttons. The form data is associated with the user account. The form data specifies the subject matter of the directive. The form data for a user is stored in one or more databases 160, 165 of the system. The user may retrieve, edit, deactivate and otherwise modify the user's form data using the portal.

The system may receive location information from users in the form of a location directive. Location information may comprise a home address, a business address, one or more other addresses, or a current location of the user as determined from location data such as GPS data from a user's smart-phone or other electronic device. The system may utilize a location directive to provide, to a consumer-user, local marketing objects responsive to a directive.

Businesses may create, modify, activate and deactivate advertisements and coupons using the portal. The portal allows businesses to manage marketing directives. Business users may track all of their marketing directives and associated advertisements, coupons and other marketing objects using the portal. An existing marketing directive may be modified, activated, deactivated, renewed and reactivated. New marketing directives may be created. The value of a coupon may be changed by a business. A business may temporarily limit a coupon to a day, days, weeks, months or any combination of dates. Usage data for a marketing directive may be monitored. Reports may be produced to summarize marketing directives and associated data. Additionally, using the portal, a business may create a web page, which may include a description of the business, its products, key personnel and contact information.

A specific directive may include current location information for a user. Thus a user may request a location-specific marketing object. Location information may be specified by a user in a directive (e.g., via entering an address, zip code, city or some other geographical identifier), or by selecting a capture location button, or automatically using a GPS receiver (or other means) of the computing device. In the latter case, upon installation of an app or upon first use, a user may authorize automatic location determination from a device's available GPS receiver or by other means (as discussed above).

Where location specific directives are processed, the service provider system 155 may respond with marketing objects for the particular location or in the vicinity. The vicinity may be defined by one or more zip codes, a geographical area defined by a radius, or some other means for determining nearby merchants. The vicinity may be limited by a mode of travel, as inputted by a consumer. By way of example, the vicinity, for walking, may comprise a more limited area than the vicinity for driving. In one preferred embodiment, the service provider system 155 responds with a number of marketing objects for the closest merchants of the type requested. For example, the service provider system 155 may respond with five, seven, ten or some other number of coupons for the closest restaurants of the type requested in a consumer directive.

By setting a vicinity as described above, the distance a user may travel to take advantage of an offer may be set by the user, so that offers too far away will be filtered. Conversely, businesses may want to target local consumers, limiting their marketing directives to users within specified geographic areas. Again, this may be accomplished by setting a vicinity for a marketing directive.

The service provider system 155 archives directives, including the date and time of the directive, a geographic identifier (e.g., zip code) for the directive, and the subject matter requested. Each directive is associated with a user's account. The archived information is useful. Knowing how many requests for a particular type of merchant in a particular geographic area and on what days and at what times, is useful for determining whether and how a local merchant may benefit from participating in a system according to principles of the invention. Such information is also useful to existing and prospective participating merchants and advertisers. Concomitantly, savings realized by consumer-users and other successes may be determined from the archived data.

Marketing objects provided with the system may include a unique code for each copy provided to each user. For example, the code may be a field (e.g., function) that is based upon the user's unique identification. In this manner, it is possible to determine not only how many marketing objects (e.g., coupons) were distributed, but also, how many were actually used and by whom.

In one implementation, upon receiving data in response to a request for merchants of a particular type, the consumer's computing device 120, 125, 135-150 may receive from the server 155 and display data pertaining to merchants of the type requested in the vicinity of the consumer. Such data may include graphical, textual, audio and video information, one or more of the foregoing, individually and in combinations. The data may include a merchant's name and address, contact information for the merchant, location information for the merchant, popularity as determined from cumulative total selections by consumers, consumer rating information such as a numerical rating or icon rating using notations such as a number of stars, spoons, chef's hats or the like, or some other indicator of a degree of consumer satisfaction. Thus, for example, a consumer computing device 120, 125, 135-150 may display a hyperlinked list of local merchants of the requested type in a particular order. The default order of display may be user selectable or fixed. The order of displayed local merchants may be sorted by proximity, consumer ratings, popularity, or some other distinguishing category.

Using one or more applications executed on the computing device 120, 125, 135-150, a consumer may navigate through the list, select a merchant to view additional information about the merchant, initiate an order process and input information and make selections to complete an order. Thus, for example, in the case of a list of local restaurants, a consumer may select a particular restaurant to view a menu for the restaurant. Additional information for a merchant may be provided from the service provider's system via the Internet 100 as a merchant is selected. Using the computing device 120, 125, 135-150, a consumer may navigate from the menu, back to the list, where the user can select another restaurant and continues reviewing menus. A menu may include product or service descriptions, product or service images, audio, video, pricing information, hyperlinked consumer reviews, and other information. Menu details may be displayed as selectable pictograms. Thus, menu items may be user selectable using the computing device 120, 125, 135-150 to add to a consumer's online shopping cart for the system. A user selectable button (i.e., user interface element that provides a user a way to trigger an event) for adding an item to a cart may be provided. When a menu item is selected or when a corresponding add to cart or purchase icon is selected, using the computing device 120, 125, 135-150, then the consumer is prompted to enter any necessary additional information, such as quantity or special requests (e.g., hold the pickles). An add-to-cart button may be associated with a quantity drop down list or combo box for specifying a quantity for an item added to a shopping cart. The menu item, quantity, and additional information may be stored in a shopping cart associated with a consumer's account. One example of such additional information, as indicated above, is special requests such as food preparation requests. Other types of special requests may include deferred delivery or recurrence. For example, a consumer may place an order for processing and pickup at a future date. As another example, a consumer may place a recurring order, e.g., a recurring weekday coffee order.

As another example, a subject matter of interest in a consumer directive may be a particular entertainer such as a specific musician, band or comedian. A marketing directive may identify as the subject matter of the marketing directive such entertainer in a particular location. The marketing object may comprise an announcement of a performance scheduled at that location and information pertaining to ticket sales. The system may send the marketing object to all users in the vicinity of the location who have identified the specific entertainer or genre of entertainment in a consumer directive. Thus, consumers may be notified of live performances, special appearance, book signings, talk show appearances by a particular celebrity, and the like.

As another example, which is a variation of the preceding example, subject matter of interest in a consumer directive may be a particular genre of live entertainment such as live rock, live country, stand-up comedy, a television show, an actor, a book or an author. A marketing directive may identify as the subject matter of the marketing directive a particular entertainer in a particular genre of entertainment performing live in a particular location. The marketing object may comprise an announcement of a performance scheduled at that location and information pertaining to ticket sales. The system may send the marketing object to all users in the vicinity of the location who have identified either the particular entertainer or genre in a consumer directive.

As another example, a consumer directive may identify a particular restaurant or a particular type of restaurant, or all restaurants. A marketing directive may be submitted for a restaurant in the vicinity of the consumer's then-current location, or in the vicinity of an address associated with the consumer. In each case, the marketing object associated with each such marketing directive will be made available to the consumer by the system.

As yet another example, a specific directive may seek all coupons for a particular retailer. Each active marketing directive from the retailer for a coupon may be retrieved in a query run in response to the specific directive. The associated coupons, as marketing objects, may then be made accessible to the consumer.

As still another example, a specific directive may seek all coupons for a particular manufacturer. Each active marketing directive from the manufacturer for a coupon may be retrieved in a query run in response to the specific directive. The associated coupons, as marketing objects, may then be made accessible to the consumer. Alternatively, a directive may seek marketing objects representing savings (e.g., coupons, sales or discounts) of a certain level for a particular product or range of products.

As another example, a specific directive may seek a coupon for a particular product. Each active marketing directive for a coupon for the product may be retrieved in a query run in response to the specific directive. The associated coupons, as marketing objects, may then be made accessible to the consumer. The product may be identified by a UPC code, brand and model, or by a barcode (e.g., a barcode imaged by a user using a mobile device).

A unique identifier is associated with each user. The identifier may be assigned at the time the user registers. Similar to a consumer loyalty card account number, the identifier may be utilized at compatibly equipped points of sale, whether brick and mortar or online, to apply coupons. To be compatibly equipped, the point of sale must be configured to transmit data to and receive data from a system according to principles of the invention. A user may be required to enter a PIN or password at checkout to authorize the transaction. The identifier may be stored on a magnetic stripe, as a scannable/readable barcode, electronically in a smart card, or on the display screen of a mobile computing device, or in a wirelessly communicated signal, or in a data packet communicated via network communication. The identifier not only identifies the user, but also identifies the system. Therefore, the point of sale system may poll the system of the invention for applicable coupons for the user.

In one embodiment, a Web crawler systematically browses the World Wide Web for the purpose of populating the databases 160, 165 with system-generated marketing directives. Starting with a list of seed URLs, the Web crawler visits the URLs, identifies all the hyperlinks in the page and adds them to the list of URLs to visit. Such URLs are recursively visited according to a set of policies. The crawler copies and saves website information as it goes. Copied information may include photos, product descriptions, pricing information, and URLs for each product on-sale on a website visited by the crawler. This information may be used to create a system-generated marketing directive and can be completely synchronized to match the consumer directives. (e.g., reduced pricing to specific marketing objects) The system may employ a metric of importance for prioritizing Web pages, by evaluating intrinsic quality and popularity in terms of links or visits. The importance of a page for the crawler can also be expressed as a function of the similarity of a page to a given query.

The system-generated marketing directive is associated with the product description and photo as a marketing object. The marketing object will be forwarded to each user with a consumer directive that matches a marketing directive. The marketing object may be stored in the database 170.

As repositories for product information, the databases 160, 165 may supply data to one or more online storefronts. The system may provide one or more store fronts for online shopping. The storefront is a Web store that is accessed by users to shop. Products offered for sale may be presented from the databases. Users may shop for goods and services via the storefront. Merchants may include their products in the store using a storefront administration system or by listing the products through marketing directives. A purchase icon may be displayed with items identified in marketing directives and on product pages of the storefront. Category, product, and other pages (e.g., search, bestsellers, etc.) may be dynamically generated by the storefront based on the information saved in the store database. By selecting a purchase icon, a shopping cart system is triggered. The shopping cart system is e-commerce software on a web server that allows users to select and accumulate a list of items for purchase. Upon checkout, the system calculates a total for the order, including shipping and handling (i.e., postage and packing) charges and taxes, as applicable. The shopping cart system provides a means of capturing a client's payment information. In the case of payment by credit card, the system relies on a secure gateway provider, in conjunction with the secure payment gateway, in order to conduct secure credit card transactions online. A store administration system may be accessed by the merchant to manage the online shop. Using the administration system, a store manager may add and edit products, categories, discounts, shipping and payment settings, etc.

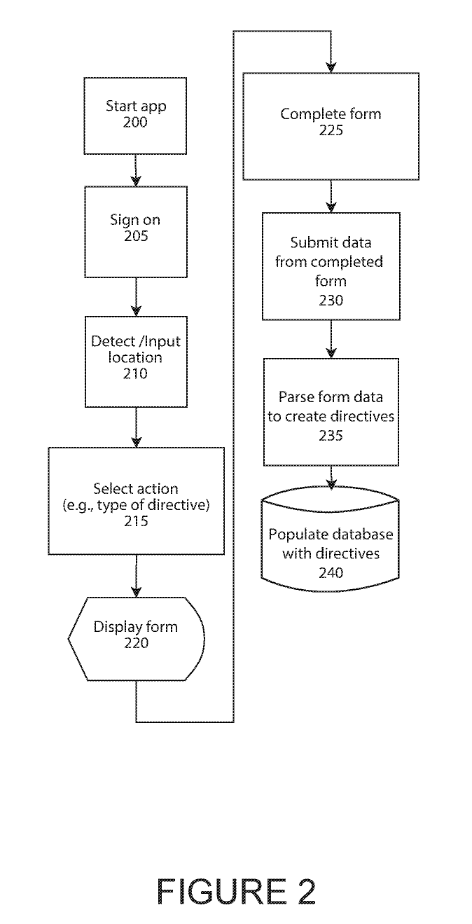

Referring now to FIG. 2, a high level flowchart conceptually illustrates steps of an exemplary directive methodology for an exemplary system according to principles of the invention. The methodology may be performed using an application, according to step 200. After signing in, as in step 205, the location of the user may be determined using any of the location determination techniques discussed above, as in step 210. The user then selects the action to be performed, from a plurality of available actions, as in step 215. Among the available actions is creating a new request. The action may be identified in lay terms as “Request Coupon” or “Request Marketing Info” or the like. Upon selecting the action the user is presented a form to complete, as in step 220. The form may include controls and fields to gather information for the directive. The directive is associated with the user's account and the time and date. After the user completes the form, as in step 225, it is submitted to the database management system 170, where it is stored as one or more records in a database 160, 165, as in step 230. The system parses the form data, as in step 235, to create records (e.g., directives) to populate the databases 160, 165, as in step 240.

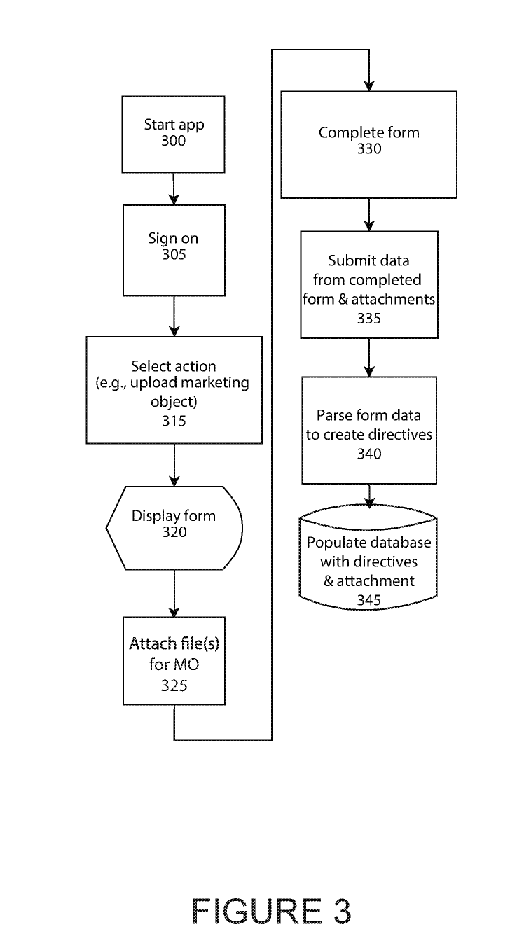

FIG. 3 provides a high level flowchart illustrating steps of an exemplary marketing directive methodology for an exemplary system according to principles of the invention. The methodology may be performed using an application, according to step 300. After signing in, as in step 305, a business-user selects the action to be performed, from a plurality of available actions, as in step 315. Among the available actions is creating a new marketing directive. Upon selecting the action the user is presented a form to complete, as in step 320. The form may include controls and fields to gather information for the directive. The directive is associated with the user's account and the time and date. One or more marketing objects, such as a coupon, is associated with the directive and uploaded, as in step 325. After the user completes the form as in step 330 and attaches the object as in step 325, the data and object are submitted to the database management system 170, as in steps 335. The system parses the form data, as in step 340, to create records (e.g., directives) to populate the databases 160, 165, as in step 345.

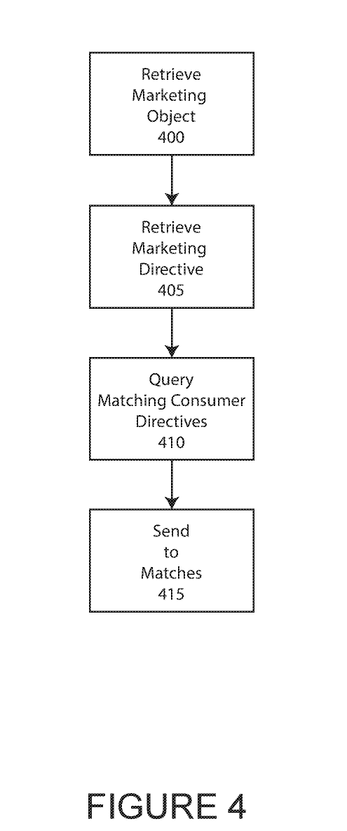

FIG. 4 provides a high level flowchart illustrating steps of an exemplary matching methodology for an exemplary system according to principles of the invention. The system 155 retrieves a marketing object and marketing directive in steps 400 and 405. Then, in step 410, in accordance with the specifications of the marketing directive, the system queries the database(s) 160, 165 to determine which consumer directives match the marketing directive. The marketing object is sent to users associated with matching consumer directives in step 415.

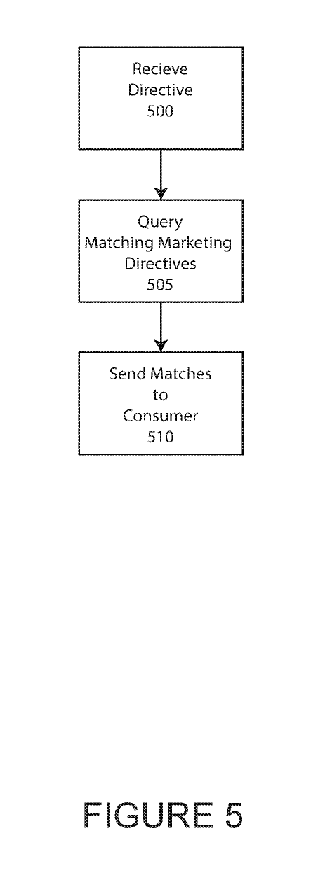

FIG. 5 is a high level flowchart illustrating steps of an exemplary specific directive processing methodology for an exemplary system according to principles of the invention. Upon receiving a specific directive (e.g., a consumer-user's request for a coupon or some other marketing object), as in step 500, the system queries the database in accordance with the specific directive, searching for matching marketing directives and associated marketing objects in the database(s), as in step 505. Matching marketing objects are sent to the user, as in step 510. Thus, a user may submit a directive that requests a coupon for a particular product or service. In response, the system will locate marketing objects responsive to the submission.

In one embodiment, a system according to principles of the invention disseminates marketing objects of marketing directives that are responsive to consumer directives upon receipt of the marketing directive. The marketing directive may be input by a vendor or obtained by an automated process, such as web crawling. Upon receipt of a marketing directive, the system determines the consumer directives, if any, to which it is responsive, and disseminates the marketing objects associated with the marketing directives in an appropriate manner, as soon as possible. In this manner, a consumer may receive timely notifications of time-sensitive sales, events, news and other matters.

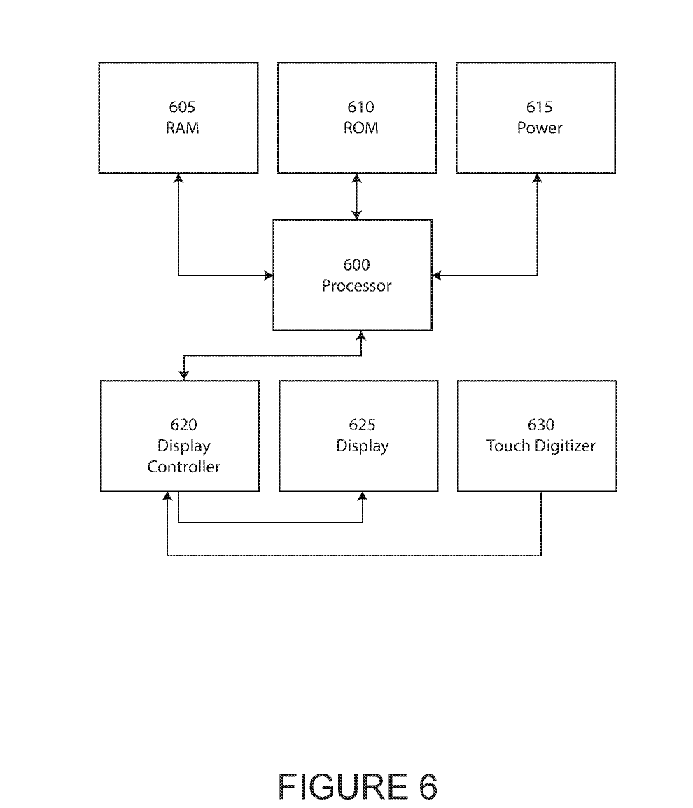

Mobile device 120, 125 is a computing device as described above in reference to FIG. 1. With reference to FIG. 6, the device 120 may include one or more processing units (CPU's) 600, memory such as RAM 605 and ROM 610, and a power supply 615. Additionally, the device 620 may include a display controller 620, a display 625 and a touch digitizer 630. These may comprise merely a few of the components of the mobile device 120. Various components may be implemented in hardware, software, or a combination of both hardware and software, including one or more signal processing and/or application specific integrated circuits.

The touch digitizer 630 comprises a touchscreen, an electronic visual display that the user can control through simple or multi-touch gestures by touching the screen with a special stylus/pen and-or one or more fingers. The touchscreen enables the user to interact directly with what is displayed, rather than using a mouse, touchpad, or any other intermediate device (other than a stylus, which is optional for most modern touchscreens). The touch digitizer 230 further comprises a transparent overlay covering the visual display. The overlay senses the touch of one or more fingers or a stylus. In response to a touch, the overlay produces a change in electrical properties (e.g., a change in current, voltage, capacitance or resistance). The touch digitizer interprets the commands that the changed electrical properties represent and communicates the commands to the appropriate applications. The touch digitizer 230 further comprises a display controller that receives and/or sends electrical signals from and to the visual display and overlay. Visual output may include graphics, text, icons, video, and any combination thereof (collectively termed “graphics”). In some embodiments, some or all of the visual output may correspond to user-interface objects. The display controller (along with any associated modules and/or sets of instructions in memory) detect contact (and any movement or breaking of the contact) on the overlay and converts the detected contact into interaction with user-interface objects (e.g., one or more soft keys, icons, web pages or images) that are displayed on touch-sensitive display. In an exemplary embodiment, a point of contact between touch digitizer 230 and the user corresponds to a finger of the user. The visual display may comprise LCD (liquid crystal display) technology, LPD (light emitting polymer display) technology, or LED (light emitting diode) technology, although other display technologies may be used in other embodiments. The overlay and display controller of the touch digitizer 630 may detect contact and any movement or breaking thereof, including speed (magnitude), velocity (magnitude and direction), and/or an acceleration (a change in magnitude and/or direction) of the point of contact, using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display. These operations may be applied to single contacts (e.g., one finger contacts) or to multiple simultaneous contacts (e.g., “multitouch”/multiple finger contacts).

Different gestures on the touch-sensitive surface have different contact patterns. Thus, a gesture may be detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event.

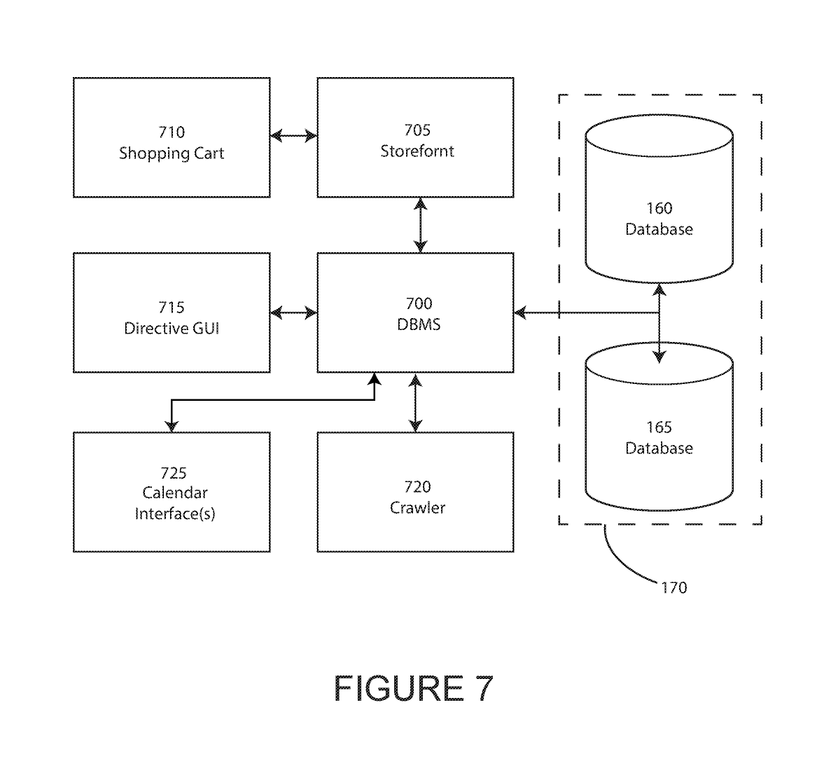

Referring now to FIG. 7, various modules of an exemplary system according to principles of the invention are conceptually illustrated. Modules may be implemented in hardware and/or in software (including firmware, resident software, micro-code, etc.). The database management system 700 (DBMS) stores, updates, sorts, queries and analyzes structured data in one or more databases 160, 165, and produces reports and output based on the data. Collectively, the databases are referred to as a database 170 or a repository or the like.

As repositories for product information, the database 170 may supply data to one or more online storefronts. The system may provide one or more storefronts 305 for online shopping. The storefront 705 is a Web store that is accessed by users to shop. Products offered for sale may be presented from the database 170. Users may shop for goods and services via the storefront 705. Merchants may include their products in the store using a storefront administration system or by listing the products through marketing directives. A purchase icon may be displayed with items identified in marketing directives and on product pages of the storefront. Category, product, and other pages (e.g., search, bestsellers, etc.) may be dynamically generated by the storefront based on the information saved in the database 170. By selecting a purchase icon, a shopping cart system 710 is triggered. The shopping cart system 710 is e-commerce software on a web server that allows users to select and accumulate a list of items for purchase. Upon checkout, the system 710 calculates a total for the order, including shipping and handling (i.e., postage and packing) charges and taxes, as applicable. The shopping cart system 710 provides a means of capturing a client's payment information. In the case of payment by credit card, the system 710 relies on a secure gateway provider, in conjunction with the secure payment gateway, in order to conduct secure credit card transactions online. A store administration system may be accessed by the merchant to manage the online shop. Using the administration system, a store manager may add and edit products, categories, discounts, shipping and payment settings, etc.

Using the computing device 120, 125, 135-150 and client software such as a browser or app, a user may create a directive. A Directive GUI 715 is the user interface for users to create and manage directives and implement slide-by displays. The interface includes controls and fields for directive creation and management and display of results. Management may entail activating, deactivating, reactivating, modifying and canceling a directive. As discussed above, each directive comprises an authoritative instruction pertaining to delivery of an electronically deliverable marketing object. The directive may be a consumer directive or a marketing directive. A consumer directive may be one of many different types, including, but not limited to, a location directive, a personal information directive, a general directive and a specific directive. The system stores data for each directive as one or more records in the database 170. Using the Directive GUI, a user may access, change and delete directives using the system. The GUI 715 allows a user to identify and select existing directives of that user and create new directives. A selected existing directive may be managed using the GUI 715. All existing directives may be displayed in a table, showing their title, creation date, effective dates, and other information related to the directives, to facilitate tracking and management.

One or more interfaces 725 allow communication of event data according to the API for each user's web calendar. The computer system adds events to calendar data for calendar's associated with the users. The event identifies the subject matter and includes a time. The addition is accomplished by sending the data for the event to the address for the calendar application in accordance with an API for the calendar application. Thus, for example, a user's calendar data is updated with a new event for the a directive.

A web crawler 720 systematically browses the World Wide Web for the purpose of populating the database 170 with system-generated marketing directives. Starting with a list of seed URLs, the Web crawler visits the URLs, identifies all the hyperlinks in the page and adds them to the list of URLs to visit. Such URLs are recursively visited according to a set of policies. The crawler copies and saves website information as it goes. Copied information may include photos, product descriptions, pricing information, and URLs for each product on-sale on a website visited by the crawler. This information may be used to create a system-generated marketing directive. The system may employ a metric of importance for prioritizing Web pages, by evaluating intrinsic quality and popularity in terms of links or visits. The importance of a page for the crawler can also be expressed as a function of the similarity of a page to a given query. Crawler process may also be created from semantic intelligence which translates and coverts human language to machine language.

Data may be supplied to the database 170 through other sources. As an example, a data feed may be provided for the database 170 to receive updated data from supplier (e.g., vendor and/or designer) data sources (e.g., databases). By way of example and not limitation, a CSV data feed may be used to load a CSV file to load product information from a supplier's database. The file may contain all data for all products from the supplier's database. Alternatively, the file may contain data for products that have changed since the last CSV file provided.

Data may also be supplied to the database 170 through the synchronization. One-way file synchronization, i.e., mirroring, may also be employed to update data copied into the database 170 from a supplier's data sources. Consistency among data from a supplier's source to the target data storage 170 may be established by timestamp synchronization. In this implementation, all changes to the source data are marked with timestamps. The time of all synchronizations are stored, at the source, at the target or at both locations. Synchronization proceeds by transferring all data with a timestamp later than the previous synchronization.

A supplier may also provide a portal (e.g., an enterprise information portal) (EIP), as a framework for making product information available. An administrator of a system according to principles of the invention may access the supplier's data through the supplier's EIP. Additionally, a system according to principles of the invention may automatically access the supplier's data through the supplier's EIP, such as by using a crawler to systematically browse the portal to update indexes and data in the database 170.

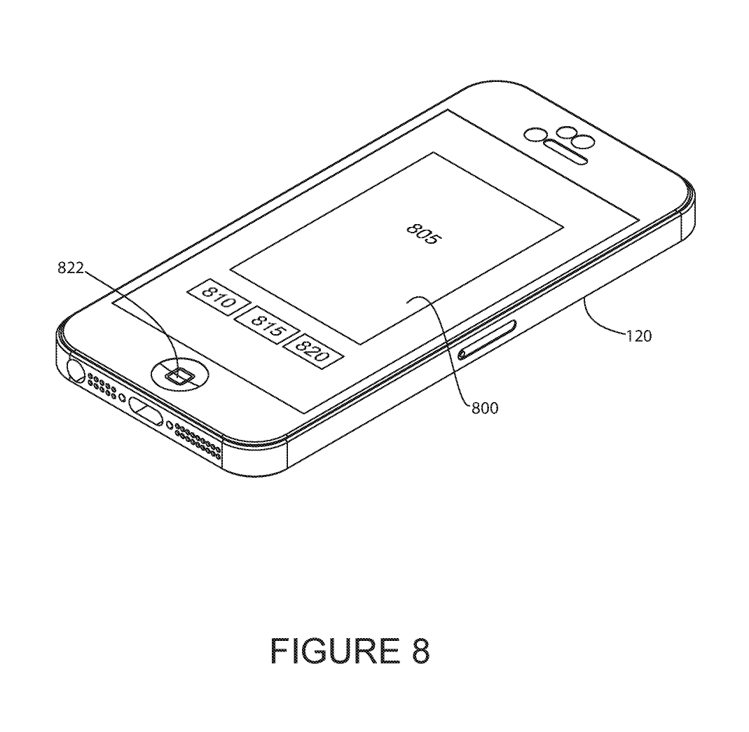

Referring now to FIG. 8, an exemplary mobile device 120 with a touch sensitive screen for use with an exemplary system according to principles of the invention is shown. The exemplary screen 800 displays a marketing object 805 and controls 810-820. The marketing object may be a coupon, discount code, product listing, product pictogram, or some other visual object. While three controls are shown, additional controls may be provided and located and arranged differently than as shown. The controls 810-820 trigger actions relative to the marketing directives and marketing object 805. The marketing object 805 may be removed from the screen 800 by swiping motion. In such case, the next or previous marketing object 805 in a series of marketing objects may be displayed on the screen 800. If there are no other marketing objects to display, a default display may be presented.

The displayed controls 810-820 may be dynamic, changing their content and functionality to work with the displayed marketing object 805. In one embodiment, the controls 810-820 may include a join button which allows a user to join an aggregate directive. Other possible controls 810-820 include a share button, allowing a user to send the marketing object or a link thereto to a friend; a block button, allowing a user to block such marketing object in the future; and a button to bring up more available actions. These non-limiting examples illustrate one example of a range of possible controls.

The app may be voice controlled. In one embodiment, control selections and other actions or directives may be performed using voice commands, using semantic intelligence which translates human language into machine language, using a microphone 822 and audio processing hardware and software of the mobile device 120.

With reference to FIG. 7, an exemplary system according to principles of the invention stores and utilizes data pertaining to directives, notifications, user sessions, products and displays (e.g., slide-by-displays) on one or more data storage devices 160-170. Data storage may be transient or enduring. Stored data may include a notification 705. A notification 705 may be generated in response to a directive 715. Notifications may be pushed from a server 155 to a user (client) 120, 125, 135-150 based upon information preferences expressed in advance by the user. Various fields of data may be associated with each notification 705, including a unique identifier (id), a time of generation, an account (e.g., user account) associated with the notification, a product or service pertaining to the notification, categories and subcategories for the product or service, a description of the subject matter of the notification, links to relevant web pages, images or pictograms for the notification, identifications for other related products and services, location information, and event time for performances, broadcast, special events, appearances and the like. Notification sending data (notification sent) 710 may be stored to ensure delivery to all intended recipients and avoid duplicates. Various fields of data may be associated with each notification sent 710 record, including a unique identifier (id) for the record, a time of generation, an account (e.g., user account) associated with the notification, a notification identification, and a directive identification.

The notification is generated when a specified condition is satisfied. Conditions and notifications vary according to the subject matter. By way of example, a user may be notified when a product becomes available, is on sale (i.e., at a discount), or is offered by a vendor at or below a certain price, or is available as a refurbished or open-box item. A user may be notified when a vendor introduces a new product or a newer version or the next generation of a product. A user may be notified when tickets to an event are offered for sale. A user may be notified when a celebrity makes an appearance locally or on television, or is interviewed, or appears in a newly released movie, or makes a public announcement. A user may be notified of each show or movie at a particular venue. These are nonlimiting examples of conditions and notifications.

A user may specify a condition for notification using a user interface with form fields. The fields vary according to the subject matter to which the notification pertains. In the case of a product, fields may include a selling price below which a user is willing to purchase the product, availability at a specified venue, coupons, public announcements, and other variables pertaining to the marketing and sale of a product. In the case of a celebrity, the conditions for which notifications may be provided may include television appearances, in-person appearances, shows, announcements and the like.

A user's calendar may be updated with a notification. This is especially useful for time constrained notifications, such as notifications of conditions that will exist for a limited time (e.g., sales, live performances, coupons with expiration dates). Illustratively, an .ics iCalendar file or other compatible calendar file or data stream may be sent (e.g. pushed) to a user's calendar app on the user's client computing device 120, 125, 135-150 to populate the local calendar with the date-related and/or time-related notification information. The process may be automated, requiring no user intervention. The process may be chronologically synchronized using auto-datafeeds.

An aggregate directive may be generated to aggregate consumer demand for a product or service and present the aggregated demand to potential providers for acceptance or counteroffer. Illustratively, a consumer user may request, in an aggregate directive, that a movie (e.g., “High Noon” the 1952 western starring Gary Cooper and Grace Kelly) be televised on a weekend evening in June. The aggregate directive may be published and disseminated (i.e, communicated) to users, including users who have expressed interest in western movies, classic movies, Grace Kelly, Gary Cooper, or other persons of interest or themes associated with the movie. When creating the aggregate directive, the originator may share it with specified users, Users who receive the directive have a chance to join the directive. When creating the aggregate directive, the originator may specify or select target providers to whom the aggregate directive should be sent. The published aggregate directive may be viewed by user-providers who are television broadcasters. Additionally, the aggregate directive may be sent to user-providers who are television broadcasters. Furthermore, the aggregate directive may be sent to providers who are television broadcasters, but not users of the system. When the aggregate directive is published or disseminated, it will include the details of the request, an expiration date (e.g., a default date such as X days after creation or a user-specified date) and the number of users that have joined in the request. An aggregate directive may also identify each provider to which the aggregate directive was sent. An aggregate directive may also provide anonymous demographic data for the consumer group, including age, gender, ethnicity, income level, and residence data for the consumer group. Users who receive the aggregate directive may specify other providers to which the aggregate directive should be sent. A consumer user who has previously originated an identical or similar aggregate directive may request consolidation of the previous aggregate directive with the current aggregate directive, combining into the consumer group all users who previously joined the earlier aggregate directive with all users who have joined the current aggregate directive. A broadcaster interested in televising the requested movie may accept the directive or conditionally accept the directive. In the latter case, for example, the broadcaster may offer to televise the movie on a different date, or televise the movie if the number of joined users in the consumer group reaches a certain minimum amount. The aggregate directive assures the broadcaster of a certain demand for the movie, based upon the number of user in the consumer group. This assured demand and demographic data may be used by a provider to garner advertising revenue through appropriate commercials. The aggregate directive expiry and date of the televised movie (assuming a provider accepts the aggregate directive) may be scheduled on the calendar app of each user in the consumer group. The calendar app will generate a reminder notification as the scheduled date and time approaches. Such scheduling provides further assurance of consumer participation, while also providing users a reminder.

As another example, a consumer user may request, in an aggregate directive, that a retailer (e.g., a sporting goods store) offer a sale on apparel. The aggregate directive may be published and disseminated (i.e, communicated) to users, including users who have expressed interest in the particular retailer, athletics or goods of the kind. When creating the aggregate directive, the originator may share it with specified users, Users who receive the directive have a chance to join the directive. When creating the aggregate directive, the originator may specify or select target providers to whom the aggregate directive should be sent. The published aggregate directive may be viewed by user-providers who are retailers (e.g., Dick's Sporting Goods) or manufacturers (e.g., UnderArmour). Furthermore, the aggregate directive may be sent to retailers and manufacturers who are not users of the system. When the aggregate directive is published or disseminated, it will include the details of the request, an expiration date (e.g., a default date such as X days after creation or a user-specified date) and the number of users that have joined in the request. An aggregate directive may also identify each provider to which the aggregate directive was sent. An aggregate directive may also provide anonymous demographic data for the consumer group, including age, gender, ethnicity, income level, and residence data for the consumer group. Users who receive the aggregate directive may specify other providers to which the aggregate directive should be sent. A consumer user who has previously originated an identical or similar aggregate directive may request consolidation of the previous aggregate directive with the current aggregate directive, combining into the consumer group all users who previously joined the earlier aggregate directive with all users who have joined the current aggregate directive. A retailer interested in providing the requested sale may accept the directive or conditionally accept the directive. In the latter case, for example, the retailer may offer the sale on a different date, or offer the sale if the number of joined users in the consumer group reaches a certain minimum amount. The aggregate directive assures the retailer of a certain level of interest for the sale, based upon the number of user in the consumer group. The aggregate directive expiry and date of the sale (assuming a provider accepts the aggregate directive) may be scheduled on the calendar app of each user in the consumer group. The calendar app will generate a reminder notification as the scheduled date and time approaches. Such scheduling provides further assurance of consumer participation, while also providing users a reminder.

As yet another example, via the Internet of Things (IoT), a consumer user's equipment registered with the system may generate a message indicating a need for supplies or service, such as replacement ink or toner cartridges for a printer. An aggregate directive may be generated for the supplies. While the aggregate directive is active (i.e., not expired), other similar messages (e.g., messages for ink and toner cartridges) may be collected and incorporated into the aggregate directive. The aggregate directive may be published and disseminated (i.e, communicated) to users, including users who have expressed interest in the particular products (e.g., ink and toner). When creating the aggregate directive, the originator may share it with specified users, Users who receive the directive have a chance to join the directive. When creating the aggregate directive, the originator may specify or select target providers to whom the aggregate directive should be sent. The published aggregate directive may be viewed by user-providers who are retailers or manufacturers of goods of the kind. Furthermore, the aggregate directive may be sent to retailers and manufacturers who are not users of the system. When the aggregate directive is published or disseminated, it will include the details of the request, an expiration date (e.g., a default date such as X days after creation or a user-specified date) and the number of users that have joined in the request. An aggregate directive may also identify each provider to which the aggregate directive was sent. An aggregate directive may also provide anonymous demographic data for the consumer group, including age, gender, ethnicity, income level, and residence data for the consumer group. Users who receive the aggregate directive may specify other providers to which the aggregate directive should be sent. A consumer user who has previously originated an identical or similar aggregate directive may request consolidation of the previous aggregate directive with the current aggregate directive, combining into the consumer group all users who previously joined the earlier aggregate directive with all users who have joined the current aggregate directive. A retailer interested in providing the requested goods may submit an offer (bid) in response to the directive. The retailer offering the lowest bid prior to expiration may be awarded the aggregate directive, The aggregate directive assures the retailer of a certain volume of sales, based upon the number of user in the consumer group. The aggregate directive expiry and date of the sale (assuming a provider accepts the aggregate directive) may be scheduled on the calendar app of each user in the consumer group. The calendar app will generate a reminder notification as the scheduled date and time approaches. Such scheduling provides further assurance of consumer participation, while also providing users a reminder.

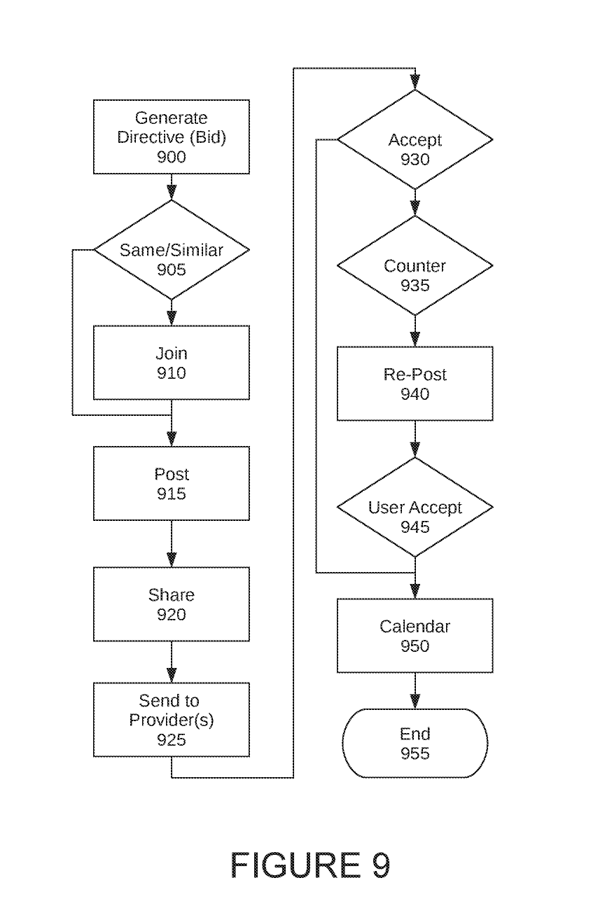

The flowchart of FIG. 9 conceptually illustrates steps of an exemplary aggregate directive process according to principles of the invention. In step 900, a directive (e.g., an aggregate directive) is generated. The system 155 may compare the directive with other directives to determine if there is sufficient similarity for consolidation, as in step 905. If a prior identical or closely similar aggregate directive exists, the user may be invited to join the prior aggregate directive, as in step 910. If not consolidated with a prior aggregate directive pursuant to step 910, the new aggregate directive may be posted (i.e., made accessible for viewing by other users), as in step 915. The aggregate directive may also be shared (i.e., communicated) to users who may be interested in the subject matter, as in step 920. The aggregate directive may be sent to potential providers, as in step 925. This entails identifying suppliers of the goods or services of interest in the aggregate directive. A provider may accept the aggregate directive, as in step 930, or counter with different or additional terms for the aggregate directive, as in step 935. In the case of a counter 935, the counter is re-posted for consideration by all users who have joined the aggregate directive, as in steep 940. Users may accept or decline the counter, as in step 945. If some users accept but others reject the counter, the counter may become a new aggregate directive for the accepting users. The creation, posting, re-posting and performance of aggregate directives is calendared, as in step 950. Performance entails fulfillment of the aggregate directive, which achieves closure 955. Notifications are provided to users via their calendar app.

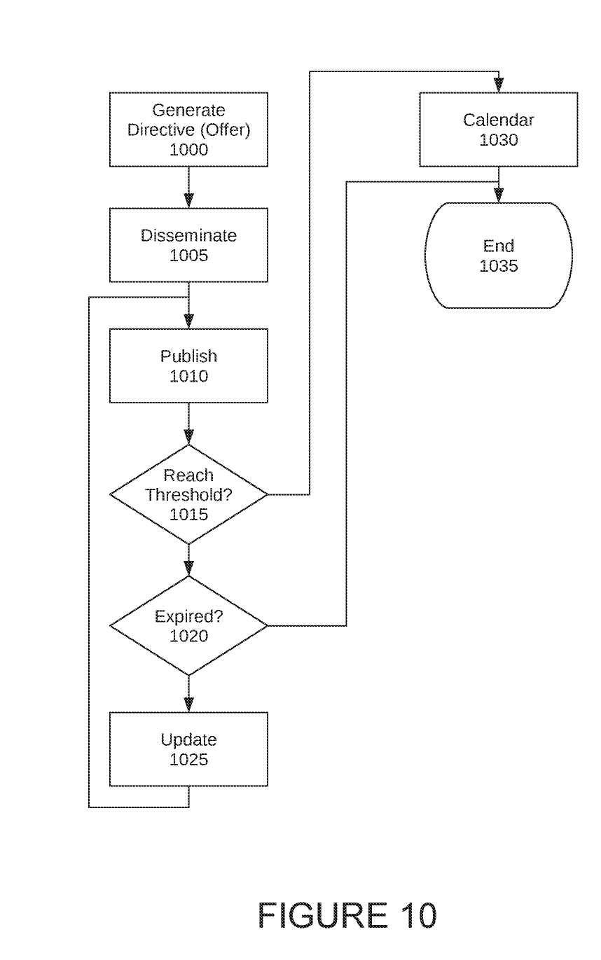

In another example, as conceptually illustrated in FIG. 10, a provider generates an aggregate directive 1000. The aggregate directive is disseminated 1005 to users who have expressed or are likely to have interest in the subject matter of the aggregate directive. The aggregate directive may also be published 1010. The aggregate directive may specify conditions for fulfillment, such as a minimum number of users in the consumer group associated with the aggregate directive. If the minimum is met before expiration 1015, performance of the aggregate directive is calendared 1030 and fulfilled 1035. If the minimum is not met 1015, but has not yet expired 1020, a provider may alter the terms (e.g., lower the minimum) to facilitate or encourage acceptance, as in step 1025. In such case, the aggregate directive is published 1010 with the updated terms 1025. If the minimum is not met 1015, and the aggregate directive has expired 1020, the aggregate directive is canceled.

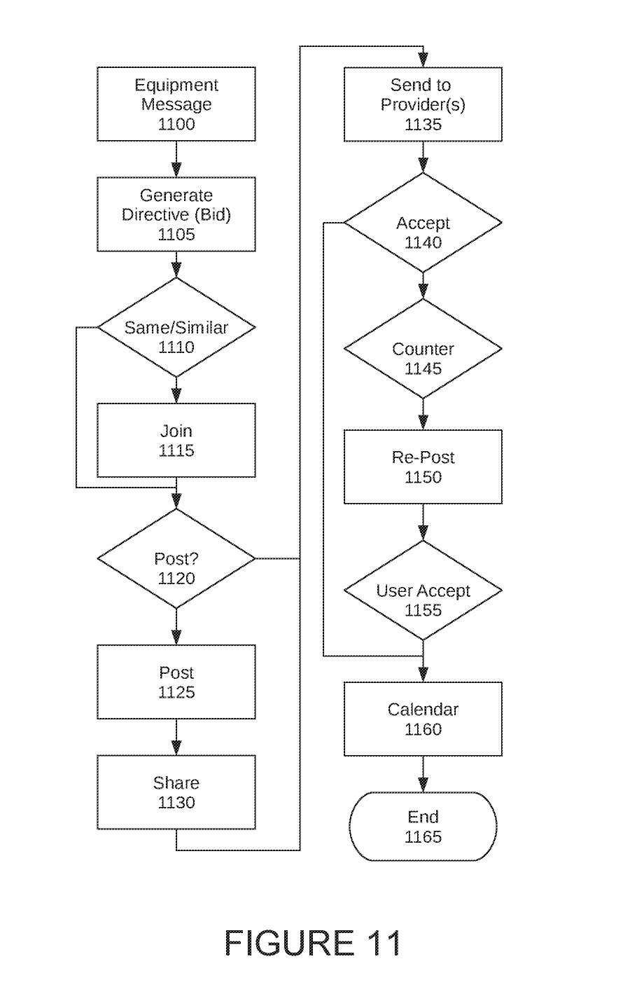

In another example, as conceptually illustrated in FIG. 11, equipment, such as a printer, generates a message 1100 communicated to the system 155, via IoT, which triggers an aggregate directive 1105. For example, a printer may generate a message indicating that it is low on toner, which may trigger an aggregate directive for toner. The system determines if the directive is identical or similar to any prior unexpired directives, as in step 1110. For example, there may be a pending aggregate directive for toner. The system 155 may compare the directive with other directives to determine if there is sufficient similarity for consolidation. If a prior identical or closely similar aggregate directive exists, the user may be invited to join the prior aggregate directive, as in step 1115. If not consolidated with a prior aggregate directive pursuant to step 1115, the new aggregate directive may be posted (i.e., made accessible for viewing by other users), as determined in step 1120 and performed in step 1125. The aggregate directive may also be shared with (i.e., communicated to) users who may be interested in the subject matter, as in step 1130. The aggregate directive may be sent to potential providers, as in step 1135. This entails identifying suppliers of the goods or services of interest in the aggregate directive. A provider may accept the aggregate directive, as in step 1140, or counter with different or additional terms for the aggregate directive, as in step 1145. In the case of a counter 1145, the counter is re-posted for consideration by all users who have joined the aggregate directive, as in steep 1150. Users may accept or decline the counter, as in step 1155. If some users accept but others reject the counter, the counter may become a new aggregate directive for the accepting users. The creation, posting, re-posting and performance of aggregate directives is calendared, as in step 1160. Performance entails fulfillment of the aggregate directive, which achieves closure 1165. Notifications are provided to users via their calendar app.

Various fields of data may be associated with each directive, including a unique identifier (id) for the record, a time of generation, an account (e.g., user account) associated with the directive, a subject for the directive, a category for the directive, each subcategory for the directive, a product or service identification for the directive, location information for the directive, and timing information for the directive.

A system according to principles of the invention may include shopping cart functionality for a user to purchase selected items. The system provides an online marketplace with shopping cart functionality. Products displayed using the system, e.g., products in an aggregate directive may be selected for purchase by selecting an add to cart icon. Each selected product may be entered into a shopping cart, which may be reviewed and modified by the user prior to completing the purchase. A user may checkout by providing shipping and payment information.

The calendar application 102 includes a user interface, which is not depicted in FIG. 1. In addition to the visual user interface, implementations provide an application programming interface (API) 110, which enables the calendar application 102 to interact with other programs (standard or custom). In some implementations, the calendar application interacts with a trigger event daemon 112 through the API 110, as described in more detail below. The trigger event daemon 112 also receives sensor signals 154 from various client device sensors 114 (e.g., sensors included with a Smart phone) and/or from other home sensors 124. Implementations typically store calendar data 106 and event data 108 in a database 104. Data is sent to and received from the calendar application 102 and the calendar API 110. In some implementations, the database 104 is a relational database, such as an SQL database. In other implementations, the database 104 is structured data stored as files on a file server. Some implementations include two or more databases. The database 104 may be stored as a CSV file, an XML file, a flat file, or in other formats.

A system according to principles of the invention may read from, write to, and modify, via the web, calendar data for calendar (e.g., Google Calendar) services that provide external access to data and functionality through an API (e.g., the Google Data Protocol). Thus, for example, a user's calendar may be updated to indicate when a pending aggregate directive expires, the date(s) and time(s) for fulfillment of an aggregate directive accepted by a supplier, and reminders for approaching deadlines. Calendared data may include text, graphics, any of which may comprise hyperlinks to other text, graphics, audio and/or video data, files or streams.

a computer network enabled calendaring method according to principles of the invention operates using a computer system with one or more computers and network (e.g., Internet) connectivity. The computer system receives via the network, a first directive. The first directive includes first directive data, which includes a first subject matter and a first user identification. The first subject matter expresses a first interest. By way of example, a user may create a directive expressing interest in a performer, or a brand, or a retailer, or a television program, or a product or a service or something else. The computer system enters the first directive data in at least one database on the computer system.

The computer system receives, via the computer network, a second directive, which includes second directive data. The second directive data includes a second subject matter responsive to the first interest and a second time associated with the second subject matter. The computer system determines if the second directive includes second subject matter responsive to the first interest. The computer system enters the second directive data in a database on the computer system. Illustratively, the second directive may offer to sell tickets to a performance, or offer goods of a particular brand, or provide information about a sale at a retailer, or provide information about a television program, or offer a particular product or service or something else in response to the first directive.

The computer system adds a first event to first calendar data for a first calendar associated with the first user identification. The first event identifies the second subject matter and includes the second time. The addition is accomplished by sending the data for the event to the address for the calendar application in accordance with an API for the calendar application. Thus, for example, the first user's calendar data is updated with a new event for the second directive.

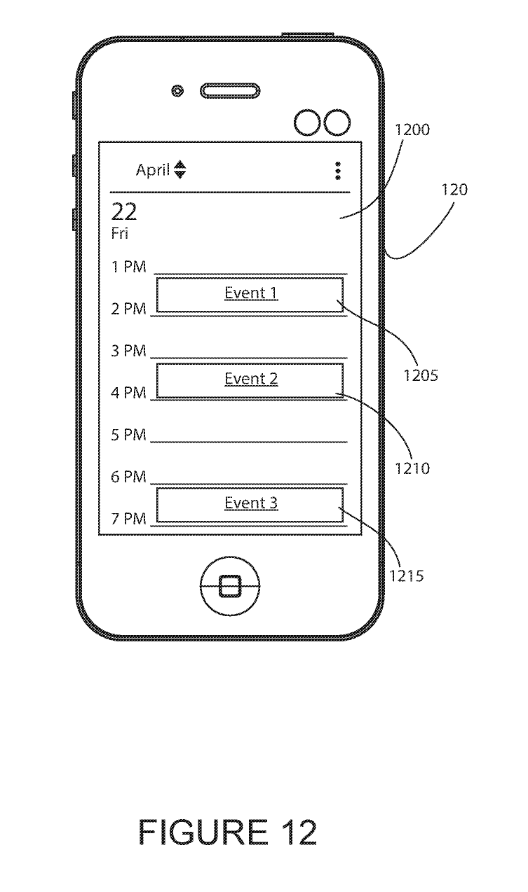

Referring to FIG. 12, an exemplary calendar 1200 for a user is displayed on a mobile device 120. One or more events 1205-1215 are displayed in corresponding time slots. The events may be links to other objects, such as web pages, video streams, text, audio streams, etc.

The first directive may be provided in a number of ways. For example, the first directive may be input by a first user via the computer network or generated from information input by a first user via the computer network, or the first directive may be generated from a message provided by equipment, via the Internet of Things (IoT). The content of such a message identifies the equipment (e.g., via a unique identifier) and contains data (e.g., a code) that defines the reason for the message (e.g., a code for a low toner warning for a printer).

The first directive may be made available to a plurality of other users. For example, the first directive or data or a link for the first directive may be shared with (e.g., emailed or texted [SMS] to) other users or published (e.g., displayed online) for viewing by other users. Such other users may become associated with the first directive by joining the first directive. Joining entails expressing assent, which may be accomplished with a control, which when selected associates the identifier for the selecting user with the directive. In this manner a plurality of users may join the directive. Such a plurality of users is referred to herein as a consumer group. The calendars of all members of the consumer group may be updated with the first event and each subsequent event relating to the directive.

Illustratively, many users may share the interest in a performer, or a brand, or a retailer, or a television program, or a product or a service or something else expressed in a first directive. By joining the first directive, the users aggregate their demand. The aggregation may appeal to potential providers and may warrant action that a single user's interest could not, in and of itself, compel.

A provider may react to the first directive in any number of ways. The provider may ignore it and not participate. The provider may assent to it in the second directive, in which the provider expresses its intent to fulfill or satisfy the interest set forth in the first directive. Illustratively, the second directive may offer to sell tickets to a performance, or offer goods of a particular brand, or provide information about a sale at a retailer, or provide information about a television program, or offer a particular product or service or something else in response to the first directive. The assent may be conditional or unconditional. An unconditional assent offers fulfillment of the interest as set forth in the first directive. A conditional assent offers fulfillment subject to certain additional or different terms. Additionally, a provider may propose, in the second directive, an alternative to the interest expressed in the first directive.

Illustratively, if a first directive calls for a particular brand and model number of toner cartridge, the second directive may offer the requested brand and model number, or may offer an alternative brand and model number that fits the same printers, or may offer something different such as a high capacity model of the toner cartridge, or may offer any combination of the foregoing.

While a user may create a directive, that is but one way of directive creation. Directives may be created by the computer system in response to determined interests. For example, a directive may be created by the computer system in response to a message received from equipment, i.e., equipment that has previously been registered with the system. Registration associates an identification for the equipment with an identification for the user. Thus, the system associates the equipment with the user. Such association may be accomplished through a directive. For instance, a first user may produce a first directive including first directive data, with a first subject matter and a first user identification, wherein the first subject matter includes a first equipment identification. The computer system enters the first directive data in at least one database on the computer system and associates the first directive data with the first user identification. Subsequently, the computer system may receive, via the computer network, a first message from the first equipment. The first message may include the first equipment identification and a first message content. By way of example, the first message content indicating a need for one of a product and service. In response, the computer system may create a second directive, including the first user identification, the first equipment identification, the first message content and a time. The computer system may then add a first event to first calendar data for a first calendar associated with the first user identification. The first event may identify the second subject matter and include the second time. The computer system may enter the second directive data in at least one database on the computer system.

Subsequently, the computer system may receive, via the computer network, a third directive. The third directive may include third directive data, with a third subject matter responsive to the first message content of the second directive, and a third time associated with the third subject matter. The computer system determines if the third directive includes third subject matter responsive to the first message content of the second directive. The computer system enters the third directive data in at least one database on the computer system. The computer system adds a second event to the first calendar data for the first calendar associated with the first user identification. The second event identifies the third subject matter and includes the third time.

The first message may be provided in a number of ways. The first message being forwarded to the system by a first user via the computer network. It may be communicated directly from the equipment to the computer system, via the Internet. The message may be a copy of a message produced by the equipment or the original message produced by the equipment.

The computer system may aggregate demand by associating the second directive with a plurality of users, such as a first user, a third user and a fourth user. Users may join the directive by entering a join command (e.g., by selecting a join control), as described above. The computer system may then add the first event to third calendar data for a third calendar for the third user and to fourth calendar data for a fourth calendar for the fourth user.

A provider may react to the second directive in any number of ways. The provider may ignore it and not participate. The provider may assent to it in the third directive, in which the provider expresses its intent to fulfill or satisfy the interest set forth in the second directive. Illustratively, the third directive may offer to sell tickets to a performance, or offer goods of a particular brand, or provide information about a sale at a retailer, or provide information about a television program, or offer a particular product or service or something else in response to the second directive. The assent may be conditional or unconditional. An unconditional assent offers fulfillment of the interest as set forth in the second directive. A conditional assent offers fulfillment subject to certain additional or different terms. Additionally, a provider may propose, in the second directive, an alternative to the interest expressed in the second directive.

In another implementation, an aggregate directive is generated by receiving, on a computer system, via a computer network, a first directive, the first directive including first directive data. The first directive data includes a first subject matter and a first user identification. The first subject matter expresses a first interest. The computer system enters the first directive data in at least one database on the computer system. The computer system provides the first directive data to a plurality of users, including a third user and a fourth user. The computer system associates the first directive with the plurality of users, including a first user, the third user and the fourth user. The first user is associated with the first user identification. The third user is associated with a third user identification. The fourth user is associated with a fourth user identification. Thus, the first, third and fourth users comprise a consumer group, each associated with the first directive, which is now an aggregate directive that aggregates the demands of the associated users.

The computer system may receive, via the computer network, a second directive, which includes second directive data with a second subject matter responsive to the first interest and a second time associated with the second subject matter. The computer system determines if the second directive includes second subject matter responsive to the first interest. The computer system enters the second directive data in at least one database on the computer system. The computer system then communicates the second directive data to the plurality of users via the computer network. The second directive data may include an assent, a conditional assent or a counter-proposal.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A computer network enabled calendaring method comprising:
receiving, on a computer system, via a computer network, a first directive, the first directive including first directive data, the first directive data including a first subject matter and a first user identification, the first subject matter expressing a first interest; and
the computer system entering the first directive data in at least one database on the computer system; and
the computer system receiving, via the computer network, a second directive, the second directive including second directive data, the second directive data including a second subject matter responsive to the first interest, and a second time associated with the second subject matter; and
the computer system determining if the second directive includes second subject matter responsive to the first interest; and
the computer system entering the second directive data in the at least one database on the computer system; and
the computer system adding a first event to first calendar data for a first calendar associated with the first user identification, the first event identifying the second subject matter and including the second time.

2. The computer network enabled calendaring method according to claim 1, the first directive being provided by a first user via the computer network.

3. The computer network enabled calendaring method according to claim 1, receiving, via the computer network, a first message from a first equipment associated with the first user identification, the first message identifying the first equipment and including a first message content, the first directive being created in response to the first message, the first subject matter comprising the first message content.

4. The computer network enabled calendaring method according to claim 1,
the computer system associating the first directive with a plurality of users, including a first user, a third user and a fourth user, the first user being associated with the first user identification, and the third user being associated with a third user identification, and the fourth user being associated with a fourth user identification; and
the computer system adding the first event to third calendar data for a third calendar associated with the third user identification, and the computer system adding the first event to fourth calendar data for a fourth calendar associated with the fourth user identification.

5. The computer network enabled calendaring method according to claim 4, the step of the computer system associating the first directive with a plurality of users, including the computer system receiving a third instruction from the third user to associate the first directive with the third user and receiving a fourth instruction from the fourth user to associate the first directive with the fourth user.

6. The computer network enabled calendaring method according to claim 1, the second subject matter comprising an assent, the assent being an indication of a second user's intent to fulfill the first interest.

7. The computer network enabled calendaring method according to claim 1, the second subject matter comprising a counter, the counter being an indication of a second user's intent to fulfill the first interest subject to a new condition.

8. The computer network enabled calendaring method according to claim 1, the second subject matter comprising a counter, the counter being an indication of second user's intent to fulfill an alternative interest, the alternative interest being a proposed substitute to the first interest.

9. A computer network enabled calendaring method comprising:
receiving, on a computer system, via a computer network, a first directive, the first directive including first directive data, the first directive data including a first subject matter, and a first user identification, the first subject matter including a first equipment identification;
the computer system entering the first directive data in at least one database on the computer system and associating the first directive data with the first user identification; and
the computer system receiving, via the computer network, a first message from the first equipment, the first message including the first equipment identification and a first message content;
the computer system creating a second directive in response to the first message, the second directive including the first user identification, the first equipment identification, the first message content and a second time;
the computer system adding a first event to first calendar data for a first calendar associated with the first user identification, the first event identifying the second subject matter and including the second time.

10. A computer network enabled calendaring method according to claim 9, the computer system entering the second directive data in the at least one database on the computer system; and

11. A computer network enabled calendaring method according to claim 9, the first message content indicating a need for one of a product and service.

12. A computer network enabled calendaring method according to claim 9, further comprising
the computer system receiving, via the computer network, a third directive, the third directive including third directive data, the third directive data including a third subject matter responsive to the first message content of the second directive, and a third time associated with the third subject matter; and
the computer system determining if the third directive includes third subject matter responsive to the first message content of the second directive; and
the computer system entering the third directive data in the at least one database on the computer system; and
the computer system adding a second event to the first calendar data for the first calendar associated with the first user identification, the second event identifying the third subject matter and including the third time.

13. The computer network enabled calendaring method according to claim 9, the first message being forwarded to the system by a first user via the computer network.

14. The computer network enabled calendaring method according to claim 9,
the computer system associating the second directive with a plurality of users, including a first user, a third user and a fourth user; and
the computer system adding the first event to third calendar data for a third calendar for the third user, and the computer system adding the first event to fourth calendar data for a fourth calendar for the fourth user.

15. The computer network enabled calendaring method according to claim 13, the step of the computer system associating the second directive with a plurality of users, including the computer system receiving a third instruction from the third user to associate the second directive with the third user and receiving a fourth instruction from the fourth user to associate the second directive with the fourth user.

16. The computer network enabled calendaring method according to claim 11, the third subject matter comprising an assent, the assent being an indication of second user's intent to fulfill the first message content.

17. The computer network enabled calendaring method according to claim 11, the third subject matter comprising a counter, the counter being an indication of second user's intent to fulfill the first message content subject to a new condition.

18. The computer network enabled calendaring method according to claim 11, the third subject matter comprising a counter, the counter being an indication of second user's intent to fulfill an alternative interest, the alternative interest being a proposed substitute to the first message content.

19. A computer network enabled calendaring method comprising
receiving, on a computer system, via a computer network, a first directive, the first directive including first directive data, the first directive data including a first subject matter, and a first user identification, the first subject matter expressing a first interest; and
the computer system entering the first directive data in at least one database on the computer system; and
the computer system providing the first directive data to a plurality of users, including a third user and a fourth user; and
the computer system associating the first directive with the plurality of users, including a first user, the third user and the fourth user, the first user being associated with the first user identification, and the third user being associated with a third user identification, and the fourth user being associated with a fourth user identification; and
the computer system receiving, via the computer network, a second directive, the second directive including second directive data, the second directive data including a second subject matter responsive to the first interest, and a second time associated with the second subject matter; and
the computer system determining if the second directive includes second subject matter responsive to the first interest; and
the computer system entering the second directive data in the at least one database on the computer system; and
the computer system communicating the second directive data to the plurality of users via the computer network.

20. A computer network enabled calendaring method according to claim 19, the second directive data comprising one of an assent, a conditional assent and a counter-proposal.
